(19) United States
(12) Patent Application Publication
(10) Pub. No.: US 2014/0280590 A1
(43) Pub. Date: Sep. 18, 2014

(54) SYSTEMS, METHODS AND APPARATUS FOR CREATING, MANAGING AND PRESENTING A SOCIAL CONTACTS LIST

(71) Applicants: Deven Scott NEMER, Thousand Oaks, CA (US); Gregory FRIEDMAN, Los Angeles, CA (US)

(72) Inventors: Deven Scott NEMER, Thousand Oaks, CA (US); Gregory FRIEDMAN, Los Angeles, CA (US)

(73) Assignee: NEVADA FUNDING GROUP INC.

(21) Appl. No.: 14/206,472

(22) Filed: Mar. 12, 2014

Related U.S. Application Data
(60) Provisional application No. 61/792,750, filed on Mar. 15, 2013.

(51) Int. Cl. G06Q 50/00

(52) U.S. Cl. CPC G06Q 50/01
USPC 709/204

(57) ABSTRACT

First information identifying a person different from the user, and a request to generate a contact page associated with the person, are received from a user, by a first server operated by a first entity. Second information that enables access to a social networking website operated by a second entity different from the first entity is received from the user. A social networking web page maintained at the social networking website is accessed, based on the second information. Third information relating to the person is obtained from the social networking web page. The contact page is generated based on the third information.

This application claims priority from U.S. Provisional Application No. 61/792,750, filed Mar. 15, 2013, which is hereby incorporated by reference herein in its entirety.

### TECHNICAL FIELD

This specification relates generally to customer relationship management systems, and more particularly to systems and methods for creating, managing and presenting a social contacts list.

### BACKGROUND

Customer relationship management (CRM) systems are widely used to help businesses manage customer data and customer interaction, access business information, manage employee, vendor and partner relationships, etc. Accordingly, one common function of a CRM system is the management of contacts lists. A contacts list system enables a user to compile information concerning various individuals of interest, including business contacts, friends, family members, etc. This function has recently begun to intersect with the functionalities of social networking websites, which allow users to post and share personal information and view information posted by other users, compile lists of friends, etc. While the functionality of these two types of applications overlap, existing systems fail to merge the functionality of a CRM-based contacts list and a social network.

### SUMMARY

In accordance with an embodiment, a method of managing a contacts list for a user is provided. First information identifying a person different from the user, and a request to generate a contact page associated with the person, are received from the user, by a first server operated by a first entity. Second information that enables access to a social networking website operated by a second entity different from the first entity is received from the user. A social networking web page maintained at the social networking website is accessed, based on the second information. Third information relating to the person is obtained from the social networking web page. The contact page is generated based on the third information.

In one embodiment, the person is added to a contacts list of the user.

In another embodiment, the social networking web page is associated with the person.

In another embodiment, the second information includes a username and a password. The third information may comprise one of an address, an email address, a telephone number, an image, a preference, and a name of an employer.

In another embodiment, the contact page is provided to the user via a websocket connection.

In accordance with another embodiment, a method of managing a contacts list is provided. A user device is caused to display a list of contacts on a display. A selection of a contact from among the list of contacts is received from the user device, via a websocket connection. Information associated with the selected contact is provided to the user device, via the websocket connection. The user device is caused to display simultaneously the list of contacts, in a first region of the display, and information associated with the selected contact, in a second region of the display.

In another embodiment, a selection of a second contact from the list of contacts is received from the user device, via the websocket connection. Information associated with the second contact is provided to the user device, via the websocket connection. The user device is caused to display simultaneously the list of contacts, in the first region of the display, and information associated with the second contact, in the second region of the display.

In one embodiment, the first region is located in a left side of the display, and the second region is located in a central and right side of the display.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a network manager in accordance with an embodiment;

FIG. 3 shows components of a social contacts manager in accordance with an embodiment;

FIG. 4 shows a user login page in accordance with an embodiment;

FIG. 5 shows a network manager and a plurality of user devices connected by respective websocket connections in accordance with an embodiment;

FIG. 6 shows a menu page in accordance with an embodiment;

FIG. 7 shows a create profile page in accordance with an embodiment;

FIG. 8 shows a profile page in accordance with an embodiment;

FIG. 9 is a flowchart of a method of generating a contact page in accordance with an embodiment;

FIG. 10 shows a create new contact page in accordance with an embodiment;

FIGS. 11 and 12 show respective contact pages in accordance with an embodiment;

FIG. 13 shows a notes page in accordance with an embodiment;

FIG. 14 shows a contact page in accordance with an embodiment;

FIG. 15 is a flowchart of a method of providing a contacts list and information relating to a selected contact in accordance with an embodiment;

FIG. 16 shows a communication system in accordance with another embodiment;

FIG. 17A is a flowchart of method of generating a contact page in accordance with an embodiment;

FIG. 17B is a flowchart of method of displaying a personalized social networking page in accordance with an embodiment;

FIG. 17C shows a personalized social networking page in accordance with an embodiment; and

FIG. 18 is a high-level block diagram of an exemplary computer that may be used to implement certain embodiments.

### DETAILED DESCRIPTION

FIG. 1 shows a communication system in accordance with an embodiment. Communication system 100 comprises a network 105, a network manager 135, and a social contacts manager 150. Communication system 100 also comprises a plurality of user devices 160-A, 160-B, 160-C, etc. Communication system 100 also includes a third party social network service 173.

For convenience, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. In one embodiment, user device 160 may include an Internet browser that enables a user to access content via the Internet. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Network manager 135 controls access to content and services. FIG. 2 shows components of network manager 135 in accordance with an embodiment. Network manager 135 includes a controller 210, a user registration & login module 220, a websocket module 225, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, in the illustrative embodiment of FIG. 2, a user registration database 265 containing usernames, passwords, and other information relating to various users is stored in storage 230. Network manager 135 may include other components not shown in FIG. 2.

Websocket module 225 from time to time establishes a websocket connection between network manager 135 and another device in communication system 100. As used herein, the term “websocket connection” refers to a connection established in accordance with the WebSocket protocol, which provides full-duplex communication channels over a single TCP connection. The WebSocket protocol was standardized by the IETF as RFC 6455 in 2011.

In another embodiment, a WebSocket API in Web IDL is used.

Communications conducted via a websocket connection are different from HTTP communications, because unlike HTTP, WebSocket provides for full-duplex communication. HTTP uses a request-response structure in which a client transmits a request to a server, and the server transmits a response after the complete request has been transmitted. In contrast, after an initial handshake, WebSocket does not require repeated requests and responses for each communication. Additionally, WebSocket enables streams of messages on top of TCP. Secure versions of the WebSocket protocol have been implemented for a variety of different browsers.

To establish a websocket connection, a client sends a WebSocket handshake request, in a well-known format, and the server sends a WebSocket handshake response, in a well-known format. The handshake resembles HTTP so that servers can handle HTTP connections as well as websocket connections on the same port. However, the specific fields involved, and activity after the handshake, do not conform to the HTTP protocol.

In one embodiment, websocket communications are conducted using Transmission Control Protocol (TCP) port 80.

Once a websocket connection is established, the client and server can send WebSocket data or text frames back and forth in full-duplex mode. The data is minimally framed, with a small header followed by payload. WebSocket transmissions are described as “messages,” where a single message can optionally be split across several data frames. This allows for sending of messages where initial data is available but the complete length of the message is unknown.

FIG. 3 shows components of social contacts manager 150 in accordance with an embodiment. Social contacts manager 150 comprises a user contacts module 320, a social network module 330, a notes module 340, and a storage 360. User contacts module 320 provides one or more customer relationship management functions, including, for example, functionality that enables a user to create and maintain a profile and one or more contacts lists. Use contacts module 320 stores profiles in a user profile database 372 within storage 360, shown in FIG. 3. User contacts module 320 stores contacts list information in a contacts list database 375 within storage 360, shown in FIG. 3. Notes module 340 allows one or more users to generate and store notes relating to a selected topic. Notes module 340 stores notes information in a notes database 378 within storage 360, shown in FIG. 3. Social network module 330 from dine to time accesses website maintained by a third party social network service and obtains information associated with a specified person.

In one embodiment, data is stored in one or more document-oriented databases. Thus, for example, use profile database 372, contacts list database 375, and/or notes database 378 may comprise a document-oriented database. Document-oriented databases may use any suitable encoding such as XML, YAML, JSON, BSON, etc.

Third party social network service 173 maintains a social networking website accessible via network 105. In a well-known manner, the website allows an individual to create and maintain a personalized web page containing information about himself or herself. For example, an individual's personalized web page may contain the individual's name, address, telephone number(s), email address, image, as well as information specifying the individual's hobbies, interests, preferences. A personalized web page may also include other features such as a personalized blog with posts created by the individual, lists of the individual's friends, etc. Third party social network service 173 enables the creator of a personalized web page to grant varying levels of access to selected people. Thus, for example, the creator may (1) grant to his wife access to all information on the web page; (2) grant to a friend access to all information on the web page except certain family pictures; and (3) grant to a colleague from work access only to the creator's name, telephone number and email address.

In an illustrative embodiment, a user employing user device 160-A accesses a website maintained by network manager 135. For example, the user may utilize a browser application (not shown) residing and operating on user device 160-A to access the website. Upon accessing the website, user registration & login module 220 (of network manager 135) may provide a user login page such as that shown in FIG. 4. User login page 400 includes a username field 410 and a password field 420. After the user enters a valid username and password, and is authenticated, controller 210 (of network manager 135) instructs websocket module 225 to establish a websocket connection between network manager 135 and user device 160-A. In response, websocket module 225 establishes a websocket connection between network manager 135 and user device 160-A. Referring to FIG. 5, a websocket connection 510 is established between network manager 135 and user device 160-A.

In one embodiment, network manager 135 is capable of establishing and maintaining a plurality of separate websocket connections simultaneously between network manager 135 and a plurality of user devices. FIG. 5 shows network manager 135 and a plurality of user devices 160-A, 160-B, and 160-C. While websocket connection 510 is maintained between network manager 135 and user device 160-A, a second websocket connection 520 is established between network manager 135 and user device 160-B, and a third websocket connection 530 is established between network manager 135 and user device 160-C.

In one embodiment, network manager 135 manages communications between a user device 160 and another component of communication system 100. For example, a request for data sent by user device 160-A to social contacts manager 150 is transmitted via websocket connection 510 to network manager 135, which forwards the request to social contacts manager 150. Data transmitted by social contacts manager 150 to user device 160-A in response to the request is transmitted to network manager 135 and then to user device 160-A via websocket connection 510.

After websocket connection 510 is established between network manager 135 and user device 160-A, controller 210 (of network manager 135) causes the browser on user device 160-A to display a menu page such as that shown in FIG. 6 that indicates one or more products and/or services available via the website. Menu page 600 presents a plurality of selections including a search button 610, a games button 620, a chat button 630, a store button 640, a contacts button 650, and an email button 660. Other selections may be included.

In the illustrative embodiment, the user of user device 160-A, wishing to create a contacts list, selects contacts button 650. Network manager 135 transmits the user's selection to social contacts manager 150. Social contacts manager 150, in response, detects that the user is a new user and accordingly provides a “Create Profile Page” page such as that shown in FIG. 7. Create profile page 700 comprises a plurality of fields in which the user may enter personal information, including a name field 722, an address field 724, an email field 726, a telephone number field 728, an Add image field 730, and a company field 730. The fields shown in FIG. 7 are illustrative only; in other embodiments, other fields may be included relating to other types of personal information. Create profile page 700 also comprises a social networking box 750 in which the user may specify a social networking website on which the user maintains a personalized social networking page. Social networking box 750 thus includes a social network field 752 in which a social networking website may be identified, a username field 754 and a password field 756 in which the user may specify the username and password that he or she uses to access his or her personalized page on the specified social networking website. In the illustrative embodiment, network manager 135 provides Create profile page 700 via websocket connection 510.

While in the illustrative embodiment, components of communication system 100 provide web pages which a user may view and employ to enter information, in other embodiments, other interfaces may be used to communicate with a user. For example, in another embodiment, one or more pages associated with a mobile App may be used.

In the illustrative embodiment of FIG. 7, the user enters name information (“John Doe”) into name field 722 and email information (johndoe@email) into email field 726, but leaves other fields empty. The user also specifies a social networking website (“MySocialNetwork”) in field 752, and a username and password that may be used to access a personalized page at in the associated social network. When the user wishes to proceed, the user selects a “DONE” button 785.

User contacts module 320 utilizes the information provided by the user to create a new user profile. The user profile is stored in user profile database 372 in storage 360 (shown in FIG. 3). User contacts module 320 now activates social network module 330 to access the social networking website specified by the user and obtain additional information. Social networking module 330 employs the information provided by the user in fields 752, 754, and 756 of Create profile page 700 and accesses the social network identified as “MySocialNetwork.” In the illustrative embodiment, “MySocialNetwork” is a third party social networking website maintained by third party social network service 173.

Social networking module 330 accesses the “MySocialNetwork” social networking website and uses the username and password provided by the user to access the user's personalized social networking page. Social networking module 330 examines the user's personalized page, and any other information sources accessible to the user on the “MySocialNetwork” site, in order to retrieve additional information about the user. In the illustrative embodiment, social networking module 330 obtains the user's address and telephone number, an image of the user, and the name of the user's current employer.

Social network module 330 also obtains from the user's personalized social networking page at the third party social networking website information indicating the user's hobbies, and information indicating the user's favorite song.

Social network module 330 provides the various items of information retrieved from the user's personalized page at “MySocialNetwork” to user contacts module 320. User contacts module 320 now combines the information provided by the user, and the information obtained from the user's personalized page at the third party social networking website “MySocialNetwork,” and creates a profile page for the user. FIG. 8 shows a profile page 800 for the user. Profile page 800 includes a name field 811 specifying the user's name (“John Doe”), a company field 813 specifying the user's current employer, an image 815 of the user, an email field 817 showing the user's email address, a telephone number field 819 showing the user's telephone number, and an address field 821 showing the user's address.

Profile page 800 also includes a hobbies box 832 listing the user's hobbies (hiking, music, videogames) and a favorite music field 834 indicating the user's favorite song (“Happy Song”).

Profile page 800 also includes a “Profile” button 802 and a “New Contact” button 804 along the top of the display. Profile page 800 also includes a contacts list 860 on the left-hand side of the display. Because the user has not yet created any contacts, the profile page indicates “No Contacts” in box 861.

In the illustrative embodiment, network manager 135 provides profile page 800 to user device 160-A via websocket connection 510.

In a similar manner, a contact page may be generated based on information retrieved from a social networking page maintained at a third party social networking website. FIG. 9 is a flowchart of a method of generating a contact page in accordance with an embodiment. At step 910, first information is received from a user, by a first server operated by a first entity, the first information identifying a person different from the user. A request to generate a contact page associated with the person is also received by the first server.

In the illustrative embodiment, the user now wishes to create a new contact, and selects New Contact button 804 (shown in FIG. 8). In response, user contacts module 320 provides a “Create New Contact” page such as that shown in FIG. 10. Create New Contact page 1000 includes a name field 1001, an address field 1003, an email field 1005, a telephone number field 1007, and a company field 1009. The user enters a name “Tim Brown” in name field 1001, an email address “timb@email” in email field 1005, and a telephone number (“123-555-5555”) in telephone number field 1007. The user then selects “CREATE CONTACT” button 1015.

User contacts module 320 receives the information provided by the user and creates a new contact. The new contact information is stored in contacts list database 375 within storage 360 (shown in FIG. 3).

At step 920, second information that enables access to a social networking website operated by a second entity different from the first entity is received from the user. As described above, social network module 330 receives the information provided by the user identifying the social networking website “MySocialNetwork” and the user's username and password.

At step 930, a social networking web page maintained at the social networking website is accessed, based on the second information. Social network module 330 utilizes the user's username and password to access the social networking website “MySocialNetwork” previously specified by the user to determine whether Tim Brown (the individual specified by the user in the contact information) maintains a personalized page on the social networking site. In the illustrative embodiment, social network module 330 determines that Tim Brown (the specified individual) does maintain a personalized page on “MySocialNetwork.” Social network module 330 accordingly utilizes the user's username and password associated with the social networking website to access Tim Brown's personalized social network page and obtain additional information.

At step 940, third information relating to the person is obtained from the social networking web page. Social network module 330 examines Tim Brown's personalized social network page and obtains information that is accessible based on the user's access level. In the illustrative embodiment, social network module 330 retrieves Tim Brown's address, an image of Tim Brown, the name of Tim Brown's current employer, a list of Tim Brown's hobbies, and information indicating Tim Brown's favorite sports team. Social network module 330 provides these items of information to user contacts module 320.

At step 950, the contact page is generated based on the third information. User contacts module 320 now creates a contact page for Tim Brown based on the information provided by the user and the information obtained from Tim Brown's personalized social network page. FIG. 11 shows a contact page in accordance with an embodiment. Contact page 1100 comprises includes a name field 1011 specifying the contact person's name (“Tim Brown”), a company field 1113 specifying the contact person's current employer (“ACME Corp.”), an image 1115 of the person, an email field 1117 showing the person's email address, a telephone number field 1119 showing the person's telephone number, and an address field 1121 showing the person's address.

Contact pane 1100 also includes a hobbies box 1132 listing the contact person's hobbies (cars, football) and a favorite team field 1136 indicating the user's favorite team (“San Diego Chargers”).

Contact page 1100 also includes “Profile” button 802 and “New Contact” button 804 along the top of the display. Contact page 1100 also includes contacts list 860 on the left-hand side of the display. Contacts list 860 comprises a contact tab 1162 associated with Tim Brown. Because the contact page for Tim Brown is currently being displayed, tab 1162 is shaded, as shown in FIG. 11.

In the illustrative embodiment, network manager 135 provides contact page 1100 to user device 160-A via websocket connection 510.

Suppose now that the user employs similar systems and methods to create a contact page for another person whose name is “Steve White.” The user provides one or more items of information identifying Steve White, in a manner similar to that described above. User contacts module 320 receives the information from the user, and then activates social network module 330. Social network module 330 accesses one or more pages maintained at the social networking website, based on the user's username and password (previously received from the user), and obtains additional information concerning Steve White. User contacts module 320 then creates a contact page for Steve White based on the information provided by the user and the information obtained from the social networking website.

FIG. 12 shows a contact page for Steve White in accordance with an embodiment. Contact page 1200 comprises includes a name field 1211 specifying the contact person's name (“Steve White”), a company field 1213 specifying the contact person's current employer (“Design Corp.”), an image 1215 of the person, an email field 1217 showing the person's email address, and it telephone number field 1219 showing the person's telephone number. Contact pane 1200 also comprises a first region 1253 entitled “Steve's Wall of Art” which contains several designs, and a second region 1283 entitled “Steve's Blog.”

Contact page 1200 also includes “Profile” button 802 and “New Contact” button 804 along the top of the display. Contact page 1200 also includes contacts list 860 on the left-hand side of the display. Contacts list 860 comprises contact tab 1062 associated with Tim Brown and a contact tab 1254 associated with Steve White. Because the Steve White contact page is currently being displayed, tab 1264 is shaded, as shown in FIG. 12.

In the illustrative embodiment, network manager 135 provides contact page 1200 to user device 160-A via websocket connection 510.

In accordance with another embodiment, two or more users may utilize a notes function to write notes relating to a selected topic in a collaborative manner. If notes relating to a particular individual are generated, the notes may be displayed with, or above, a contact page associated with the particular individual. Referring again to FIGS. 8 and 11, John Doe and Tim Brown are both employees of ACME Corp., as indicated by company fields 813 and 1113. In addition, both John Doe and Tim Brown are members of a team created for a particular project; the team is referred to as “Team A.” Referring again to FIGS. 8 and 11, a team symbol 844 is displayed on page 800 and on page 1100 next to each respective person's name to indicate membership in the team. Steve White, however, is not a member of Team A and therefore the contact page 1200 (shown in FIG. 12) for Steve White does not display team symbol 844.

Suppose now that Team A maintains a web page to enable team members to generate notes relating to various topics. Suppose further that John Doe and Tim Brown, in the course of their work for Team A, generate one or more notes relating to Steve White. FIG. 13 shows a notes page 1300 showing notes 1303, 1305, 1307 containing various notes written by John Doe and Tim Brown and relating to work done by Steve White. Referring to FIG. 3, notes 1303, 1305, 1307 are stored in notes database 378 within storage 360 (of social contacts manager 150).

In accordance with an embodiment, if a team member accesses a contact page associated with a selected person, any stored notes relating to the selected person are displayed simultaneously with, or above, the contact page on a display. For example, if John Doe subsequently access contact page 1200 (of Steve White), notes relating to Steve White are retrieved from notes database 378 and displayed above contact page 1200. In an illustrative embodiment shown in FIG. 14, notes relating to Steve White are shown in a region 1405 located at the bottom of the display. Note 1303 is currently visible; a scroll bar 1470 is provided to allow the user to scroll down and view additional notes.

In accordance with another embodiment, a user may view a contacts list comprising a plurality of contacts, and rapidly view information relating to each contact on the list. Referring to FIGS. 11, 12, and 14, contacts list 850 is displayed in a first region on the left side of a display, and the information relating to a selected contact is displayed simultaneously in a region located in the center and right side of the display.

Advantageously, a user may quickly obtain and view stored information relating to any selected contact in a contacts list, by selecting the desired contact from among the list displayed in the first region. Because network manager 135 maintains a websocket connection with user device 160-A, stored information relating to a selected contact is transmitted to user device 160-A without the need, for example, to complete a request-response procedure as required by the HTTP protocol each time a different contact is selected. As a result, the user's viewing experience is more rapid and is enhanced.

In accordance with another embodiment, information relating to a selected contact is streamed to user device 160 via websocket connection 510.

FIG. 15 is a flowchart of a method of providing a contacts list and information related to one or more contacts, in accordance with an embodiment. At step 1510, a user device is caused to display a list of contacts on a display. At step 1520, a selection of a contact from among the list of contacts is received from the user device, via a websocket connection. At step 1530, information associated with the selected contact is provided to the user device, via the websocket connection. At step 1540, the user device is caused to display simultaneously the list of contacts, in a first region of the display, and information associated with the selected contact, in a second region of the display.

While in the illustrative embodiments, social network module 330 accesses a social network maintained by third party social network service 173, winch is independent of network manager 135, in another embodiment, network manager 135 (or an affiliated entity) maintains a social network which users may employ to create personal profiles, etc. Social network module 330 may access such a social network and, in a manner similar to that described above, obtain information relating to one or more users of such social network in order to create a contact page.

In accordance with another embodiment, the functionality of social contact manager 150 may reside in a user device 160. FIG. 16 illustrates a communication system in accordance with an embodiment. Communication system 1600 includes network 105, network manager 135, a social network service 1673, and a plurality of user devices including user devices 160-D, 160-E, and 160-F. User device 160-D comprises a social contacts manager 1680 which has functionalities analogous to some or all of the functionalities of social contacts manager 150, as described above.

Social network service 1673 maintains an online social network in which users may create personalized social networking pages, and interact in a variety of ways. In the illustrative embodiment, social network service 1673 and network manager 135 are both controlled by the same entity, and network manager 135 controls access to the social network.

In accordance with an embodiment, a user employing user device 160-D creates a social contact page associated with another person. In an illustrative embodiment, the user of user device 160-D is a registered user of the website maintained by network manager 135 and/or a registered user of the social network maintained by social network service 1673.

FIG. 17A is a flowchart of a method of generating a contact page in accordance with an embodiment. At step 1710, first information identifying a person different from the user, and a request to generate a contact page associated with the person, are received. In a manner similar to that described above, the user of user device 160-D may select an option to create a contact page for a specified person. The user enters one or more items of information related to the person, such as the person's name and address.

At step 1720, a personalized social networking page associated with the person and maintained within an online social network is accessed. Social contacts manager 1680 accesses a personalized social networking page associated with the specified person, within the social network maintained by social network service 1673, based on the first information. For example, social network service 1673 may utilize the person's name and address to identify the person's personalized social networking page. In the illustrative embodiment of FIG. 16, because the user is a registered use of the website maintained by network manager 135 and/or a registered user of the social network maintained by social network service 1673, social contacts manager 1680 (of user device 160-D) is permitted to access various personalized social networking pages within the social network.

At step 1730, second information relating to the person is obtained from the personalized social networking page. Thus, social network service 1673 obtains additional information from the personalized social networking page, such as the person's telephone number, the person's employer, the person's email address, etc.

At step 1740, a contact page is generated based on the second information. Social network service 1673 now generates a contact page containing the first information (provided by the user) and the second information (obtained from the personalized social networking page). The contact page may be stored in a storage within user device 160-D.

In accordance with another embodiment, information is retrieved from a user's contacts list and used to enhance a display of as social networking page associated with another person.

FIG. 17B is a flowchart of a method of displaying a social networking page in accordance with an embodiment. Suppose that the user (John Doe) now wishes to view Tim Brown's social networking page on the social network “MySocialNetwork.” John Doe accordingly uses a browser application on user device 160-A and navigates to Tim Brown's personalized social networking page on the social network.

In one embodiment, the method described in FIG. 17B may be used to obtain information from a page maintained on social network controlled by or affiliated with an entity that control network manager 135. In another embodiment, the method described in FIG. 17B may be used to obtain information from a page maintained on social network that is independent of the entity that control network manager 135.

At step 1760, a request to access a social networking page that is maintained in an online social network and associated with a specified person different from the user is received from a user. Network manager 135 receives the user's request to access Tim Browns personalized networking page and forwards the request to social network manager 150.

At step 1770, first information representing the social networking page associated with the specified person is obtained via a network. Social network module 330 accesses Tim Brown's personalized page on “MySocialNetwork” and retrieves data associated with the social networking page. In the illustrative embodiment, Tim Brown's social networking page comprises an image of Tim Brown, Tim Brown's address, information concerning Tim Brown's hobbies, etc.

At step 1780, second information relating to the specified person is obtained from a contacts list associated with the user. Social network module 330 determines that Tint Brown's social networking page does not include Tim Brown's email or his telephone number. Therefore, social network module 330 access John Doe's contact list. In particular, social network module 330 accesses contact page 1100 associated with Tim Brown (shown in FIG. 11), and retrieve Tim Brown's email address (item 1117 in FIG. 11) and Tim Brown's telephone number (item 1119).

At step 1790, a combined social networking page comprising the first information and the second information is displayed, in response to the request. Social network module 330 now combines the information retrieved from John Doe's contact list and the data representing Tim Brown's personalized social networking page to generate a combined social networking page, as shown in FIG. 17C.

FIG. 17C shows a combined social networking page associated with Tim Brown in accordance with an embodiment. Social networking page 1795 comprises a name field 1791, an address field 1792, and a hobbies region showing, respectively, Tim Brown's name, address, and hobbies. Page 1795 also includes a friends region showing Tim Brown's friends, and a personal blog 1796. Page 1795 also includes an image 1797 of Tim Brown. Social networking page 1795 also comprises an email field 1787 and a telephone number field showing, respectively, Time Brown's email address and telephone number. Email field 1787 and telephone number field 1788 are shaded, indicating that the information in these fields was obtained by the viewer's contacts list.

In various embodiments, the method steps described herein, including the method steps described in FIGS. 9, 15, and/or 17, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or mere memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may gore data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 9, 15, and/or 17, may be implemented using one or more computer programs that are executable by such a processor. A computer program is a set of computer program instructions that can be used, directly or indirectly, in a computer to perform as certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 18. Computer 1800 includes a processor 1801 operatively coupled to a data storage device 1802 and a memory 1803. Processor 1801 controls the overall operation of computer 1800 by executing computer program instructions that define such operations. The computer program instructions may be stored in data storage device 1802, or other computer readable medium, and loaded into memory 1803 when execution of the computer program instructions is desired. Thus, the method steps of FIGS. 9, 15, and/or 17 can be defined by the computer program instructions stored in memory 1803 and/or data storage device 1802 and controlled by the processor 1801 executing the computer program instructions. For example, the computer program instructions can be implemented as computer executable code programmed by one skilled in the art to perform an algorithm defined by the method steps of FIGS. 9, 15 and/or 17. Accordingly, by executing the computer program instructions, the processor 1801 executes an algorithm defined by the method steps of FIGS. 9, 15, and/or 17. Computer 1800 also includes one or more network interfaces 1804 for communicating with other devices via a network. Computer 1800 also includes one or more input/output devices 1805 that enable user interaction with computer 1800 (e.g., display, keyboard, mouse, speakers, buttons, etc.).

Processor 1801 may include both general and special purpose microprocessors, and may be the sole processor or one of multiple processors of computer 1800. Processor 1801 may include one or more central processing units (CPUs), for example. Processor 1801, data storage device 1802, and/or memory 1803 may include, be supplemented by, or incorporated in, one or more application-specific integrated circuits (ASICs) and/or one or more field programmable gate arrays (FPGAs).

Data storage device 1802 and memory 1803 each include a tangible non-transitory computer readable storage medium. Data storage device 1802 and memory 1803, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1805 may include peripherals, such as a printer, scanner, display screen, etc. For example, input/output devices 1805 may include a display device such as a cathode ray tube (CRT) or liquid crystal display (LCD) monitor for displaying information to the user, a keyboard, and a pointing device such as a mouse or a trackball by which the user can provide input to computer 1800.

Any or all of the systems and apparatus discussed herein, including network manager 135, social contacts manager 150, third party social network service 173, and user device 160, and components thereof, including controller 210, user registration & login module 220, websocket module 225, storage 230, user contacts module 320, social network module 330, notes module 340, and storage 360, may be implemented using a computer such as computer 1800.

One skilled in the art will recognize that an implementation of an actual computer or computer system may have other structures and may contain other components as well, and that FIG. 18 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the in without departing from the scope and spirit of the invention. Those skilled in the in could implement various other feature combinations without departing from the scope and spirit of the invention.

1. A method of managing a contacts list, the method comprising:
receiving, by a first server operated by a first entity, from a user, first information identifying a person different from the user and a request to generate a contact page associated with the person;
receiving from the user second information that enables access to a social networking website operated by a second entity different from the first entity;
accessing a social networking web page maintained at the social networking website, based on the second information;
obtaining from the social networking web page third information relating to the person; and
generating the contact page based on the third information.

2. The method of claim 1, further comprising:
adding the person to a contacts list of the user.

3. The method of claim 1, wherein the social networking web page is associated with the person.

4. The method of claim 1, wherein the second information includes a username and a password.

5. The method of claim 1, wherein the third information comprises one of an address, an email address, a telephone number, an image, a preference, and a name of an employer.

6. The method of claim 1, further comprising:
providing the contact page to a use device via a websocket connection.

7. The method of claim 6, further comprising:
identifying one or more notes associated with the person, the notes being stored by a second server operated by the first entity; and
causing the user device to display the contact page and the one or more notes simultaneously.

8. A system comprising:
a storage adapted to store information relating to one or more persons;
a processor adapted to:
receive, from a user, first information identifying a person different from the user and a request to generate a contact page associated with the person;
receive from the user second information that enables access to a social networking website operated by a second entity different from the first entity;
access a social networking web page maintained at the social networking website, based on the second information;
obtain from the social networking web page third information relating to the person; and
generate the contact page based on the third information.

9. The system of claim 8, wherein the processor is further adapted to:
add the person to a contacts list of the user.

10. The system of claim 8, wherein the social networking web page is associated with the person.

11. The system of claim 8, wherein the second information includes a username and a password.

12. The system of claim 8, wherein the third information comprises one of an address, an entail address, a telephone number, an image, a preference, and a name of an employer.

13. The system of claim 8, wherein the processor is further adapted to:
provide the contact page to the user via a websocket connection.

14. A method of managing a contacts list, the method comprising:
causing a user device to display a list of contacts on a display;
receiving from the user device, via a websocket connection, a selection of a contact from among the list of contacts;
providing to the user device, via the websocket connection, information associated with the selected contact;
causing the user device to display simultaneously the list of contacts, in a first region of the display, and information associated with the selected contact, in a second region of the display.

15. The method of claim 14, further comprising:
receiving from the user device, via the websocket connection, a selection of a second contact from the list of contacts;
providing to the user device, via the websocket connection, information associated with the second contact;
causing the user device to display simultaneously the list of contacts, in the first region of the display, and information associated with the second contact, in the second region of the display.

16. The method of claim 14, wherein:
the first region is located in a left side of the display; and
the second region is located in a central and right side of the display.

17. A method comprising:
receiving, by a user device, from a user, a request to access a social networking page that is maintained in an online social network and associated with a specified person different from the user;
obtaining, by the user device, via a network, first information representing the social networking page associated with the specified person;
obtaining, by the user device, from a contacts list associated with the user, second information relating to the specified person;
displaying, in response to the request, on the user device, a combined social networking page comprising the first information and the second information.

18. The method of claim 17, wherein the second information comprises one of a telephone number, an email address, a name of an employer, and a residential address.
